(19) United States
(12) Patent Application Publication
(10) Pub. No.: US 2017/0099666 A1
(43) Pub. Date: Apr. 6, 2017

(54) Long Term Evolution (LTE) System Operating in an Unlicensed Spectral Band with Best-Effort Listen-Before-Talk

(71) Applicant: SpiderCloud Wireless, Inc., Milpitas, CA (US)

(72) Inventor: Hithesh Nama, San Jose, CA (US)

(21) Appl. No.: 15/281,353

(22) Filed: Sep. 30, 2016

Related U.S. Application Data
(60) Provisional application No. 62/236,311, filed on Oct. 2, 2015.

(51) Int. Cl. H04W 72/04; H04W 28/26

(52) U.S. Cl. CPC H04W 72/0453; H04W 72/0446; H04W 28/26; H04W 72/042

(57) ABSTRACT

In accordance with a method for communicating over a channel in a frequency band (e.g., an unlicensed frequency band) shared by different radio access technologies, prior to transmitting a signal beginning at a predetermined time on a first channel in a frequency band in accordance with a first radio access technology (RAT), the first channel is sensed to determine if it is unoccupied during a specified first duration of time for a specified second duration of time. If the first channel is unoccupied for the specified second duration of time, a channel reservation signal is immediately transmitted on the first channel. The channel reservation signal is decodable by a node operating in accordance with a second RAT different from the first RAT.

### CROSS REFERENCE TO RELATED APPLICATION

This application is a non-provisional of U.S. Provisional Application Ser. No. 62236311, filed Oct. 2, 2015, entitled “LTE-U with Best-effort LBT”, the contents of which are incorporated herein.

### INTRODUCTION

Operators of mobile systems, such as universal mobile telecommunications systems (UMTS) and its offspring including LTE (long term evolution) and LTE-advanced, are increasingly relying on wireless small cell radio access networks (RANs) in order to deploy indoor voice and data services to enterprises and other customers. Such small cell RANs typically utilize multiple-access technologies capable of supporting communications with multiple users using radio frequency (RF) signals and sharing available system resources such as bandwidth and transmit power.

One resource that is limited in mobile systems is spectrum (a band of frequencies over which communication can take place). Recently, LTE systems have begun to extend their operation into unlicensed frequency bands such as the 5 GHz band, which is currently primarily used by Wi-Fi systems conforming to the IEEE 802.11 specification. Some of the technical specifications being developed for the use of LTE technology with unlicensed spectrum include LTE-U (LTE-unlicensed, being developed by the LTE-U forum), 3GPP LAA (Licensed Assisted Access) and MulteFire (being developed by the MulteFire forum). Both LTE-U and LAA use a licensed anchor carrier as the primary carrier together with one or more unlicensed carriers as supplemental secondary carriers. Because of the additional frequency resources that are made available by the use of an unlicensed frequency band it is possible to assign different, non-overlapping channels to different cells, simultaneously allowing system capacity improvements and reductions in interference.

The use of the unlicensed frequency band is made possible using techniques such as a listen-before-talk (LBT) mechanism used by WiFi or pseudo-random frequency hopping used by Bluetooth. 3GPP LAA uses LBT mechanism similar to WiFi, which means that data can be transmitted on a radio channel only when the unlicensed carrier is determined to be idle. LTE-U uses a combination of careful channel selection and CSAT (channel sense with adaptive transmission) to coexist with other technologies within the unlicensed frequency band. Further, LTE-U retains the fixed frame structure of LTE i.e., downlink transmissions are aligned to subframe boundaries that do not vary with channel usage

### SUMMARY

In accordance with one aspect of the disclosure, a method is provided for communicating over a channel in a frequency band (e.g., an unlicensed frequency band) shared by different radio access technologies. In accordance with the method, prior to transmitting a signal beginning at a predetermined time on a first channel in a frequency band in accordance with a first radio access technology (RAT), the first channel is sensed to determine if it is unoccupied during a specified first duration of time for a specified second duration of time. If the first channel is unoccupied for the specified second duration of time, a channel reservation signal is immediately transmitted on the first channel. The channel reservation signal is decodable by a node operating in accordance with a second RAT different from the first RAT.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an enterprise in which a small cell radio access network (RAN) is implemented.

FIG. 2 is a flowchart illustrating a simplified example of a method for operating an LTE-U system in an unlicensed frequency band.

FIG. 3 shows the duty cycle of an LTE-U cell operating in accordance with a Carrier Sensing Adaptive Transmission (CSAT) algorithm.

FIG. 4a is a timeline showing two ON periods of the LTE-U duty cycle and FIG. 4b is a timeline showing the transmission of Wi-Fi packets on the same channel as the LTE-U cell.

FIG. 5 shows the timing sequence of the distributed coordination function (DCF) used by IEEE 802.11 protocol.

FIG. 6 is a timeline showing two ON periods of the LTE-U duty cycle when a listen-before-talk process is implemented in which the transmitter listens to the channel for a period of time T prior to the start of the transmission during the LTE-U ON periods of the LTE-U duty cycle.

FIG. 7 shows the LTE-U duty cycle of FIG. 6 in which puncturing gaps are provided during one or more of the LTE-U ON periods.

FIG. 8 is a simplified functional block diagram of one example of a UE that is configured for LTE-U operation in accordance with the techniques described herein.

FIG. 9 is a simplified functional block diagram of one example of a radio node that is configured for LTE-U operation in accordance with the techniques described herein.

### DETAILED DESCRIPTION

Various systems, methods, and apparatuses are described in which unlicensed spectrum is used for LTE communications. Various deployment scenarios may be supported including a supplemental downlink mode of operation in which the LTE primary component carrier (PCC) uses the licensed spectrum and the LTE-U secondary component carrier (SCC) uses the unlicensed spectrum. More generally, in some implementations downlink and/or uplink traffic between a cell and a UE may be offloaded to an unlicensed spectrum. The unlicensed spectrum that is employed may range, by way of example and not as a limitation on the techniques described herein, from 600 Megahertz (MHz) to 6 Gigahertz (GHz).

Moreover, the techniques described herein are not limited to LTE-based technologies (e.g., LTE-U, LAA), and may also be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of illustration, and LTE terminology is used in much of the description below, although the techniques are applicable beyond LTE applications. In this description, LTE-Advanced (LTE-A) communications are considered to be a subset of LTE communications, and therefore, references to LTE communications encompass LTE-A communications.

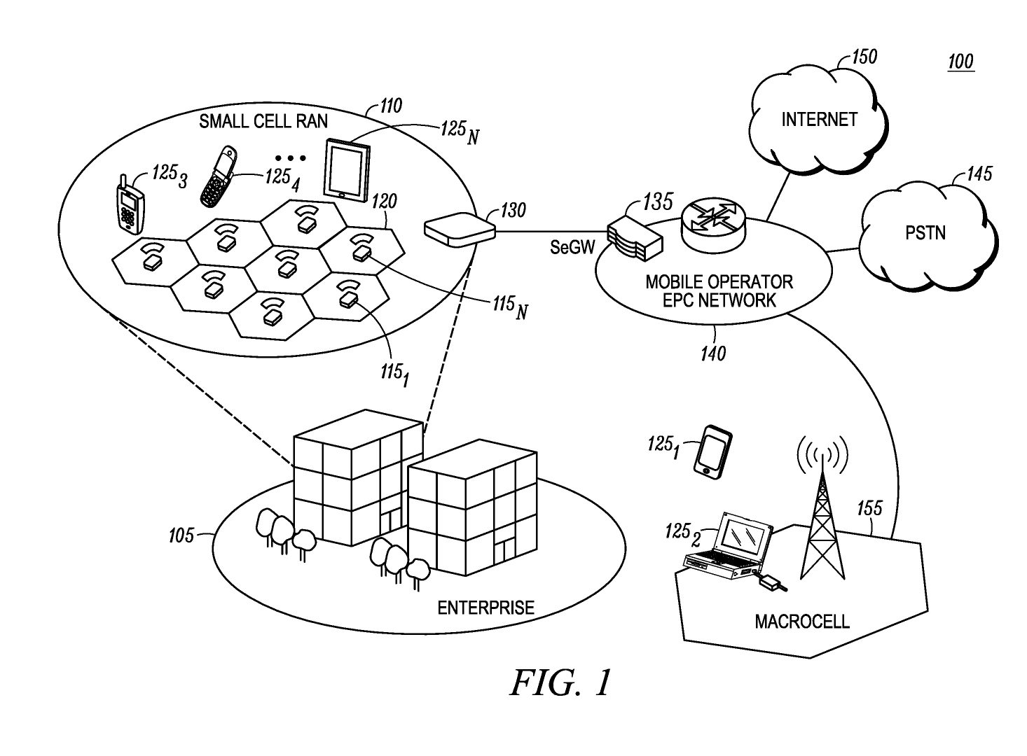

FIG. 1 shows an enterprise 105 in which a small cell RAN 110 is implemented. The small cell RAN 110 includes a plurality of radio nodes (RNs) 115₁ . . . 115_{N}. Each radio node 115 has a radio coverage area (graphically depicted in the drawings as hexagonal in shape) that is commonly termed a small cell. A small cell may also be referred to as a femtocell, or using terminology defined by 3GPP as a Home Evolved Node B (HeNB). In the description that follows, the term “cell” typically means the combination of a radio node and its radio coverage area unless otherwise indicated. A representative cell is indicated by reference numeral 120 in FIG. 1.

The size of the enterprise 105 and the number of cells deployed in the small cell RAN 110 may vary. In typical implementations, the enterprise 105 can be from 50,000 to 500,000 square feet and encompass multiple floors and the small cell RAN 110 may support hundreds to thousands of users using mobile communication platforms such as mobile phones, smartphones, tablet computing devices, and the like (referred to as “user equipment” (UE) and indicated by reference numerals 1251-N in FIG. 1).

The small cell RAN 110 includes an access controller 130 that manages and controls the radio nodes 115. The radio nodes 115 are coupled to the access controller 130 over a direct or local area network (LAN) connection (not shown in FIG. 1) typically using secure IPsec tunnels. The access controller 130 aggregates voice and data traffic from the radio nodes 115 and provides connectivity over an IPsec tunnel to a security gateway SeGW 135 in an Evolved Packet Core (EPC) 140 network of a mobile operator. The EPC 140 is typically configured to communicate with a public switched telephone network (PSTN) 145 to carry circuit-switched traffic, as well as for communicating with an external packet-switched network such as the Internet 150.

The environment 100 also generally includes Evolved Node B (eNB) base stations, or “macrocells”, as representatively indicated by reference numeral 155 in FIG. 1. The radio coverage area of the macrocell 155 is typically much larger than that of a small cell where the extent of coverage often depends on the base station configuration and surrounding geography. Thus, a given UE 125 may achieve connectivity to the network 140 through either a macrocell or small cell in the environment 100.

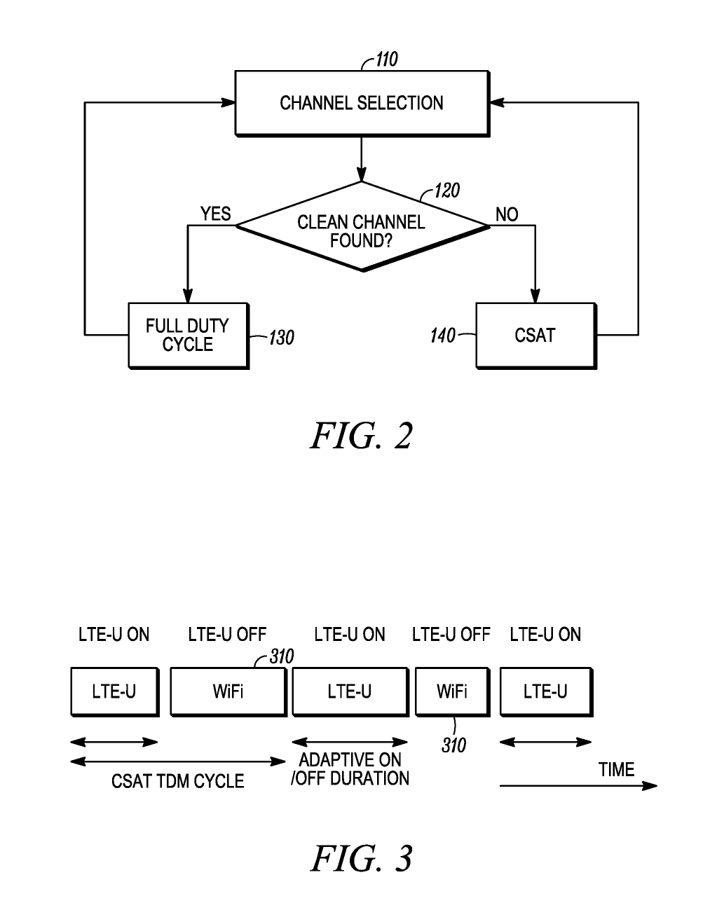

FIG. 2 is a flowchart illustrating a simplified example of a method for operating an LTE-U system in an unlicensed frequency band. The method may be used by radio nodes, base stations and/or UEs such as the RNs 115 and UEs 125 shown in FIG. 1, for example. In this example a RN uses the method to provide downlink transmissions. First, in step 110 a channel is selected by a small cell based on LTE measurements. To make the selection, the small cell scans the unlicensed band in decision step 120 and determines if a clean channel is available for the carrier transmission. This ensures that interference is avoided between the small cell and its neighboring Wi-Fi devices and other LTE-U small cells, provided an unused channel is available. If a clear channel is found, the small cell will transmit on that channel using the full duty cycle in step 130. The channel selection algorithm monitors the status of the operating channel on an on-going base, and if needed will select a more suitable one and change.

If no unused channel is available in step 120, a Carrier Sensing Adaptive Transmission (CSAT) algorithm is used in step 140 to apply time-division multiplexing based access techniques to LTE-U cells, based on long-term carrier sensing of co-channel activities of the competing technologies. In this way the two technologies can share the channel fairly. In particular, CSAT defines a time cycle and the LTE-U cell transmits in a fraction of the cycle and gates off for the remainder of the cycle. The duty cycle of transmission vs gating off is dictated by the sensed medium activity of other devices and technologies. This use of a shared channel is depicted in the timeline shown in FIG. 3. During the LTE-U OFF period 310, the channel is clean to neighboring Wi-Fi nodes, which can resume normal Wi-Fi transmissions. The small cell or UE will measure the Wi-Fi medium utilization during the LTE-U off period 310, and adaptively adjust the on/off duty cycle accordingly. The TDM cycle can be set to a few hundreds of msec, for instance, which can effectively accommodate the activation/de-activation procedures while controlling the data transmission delay.

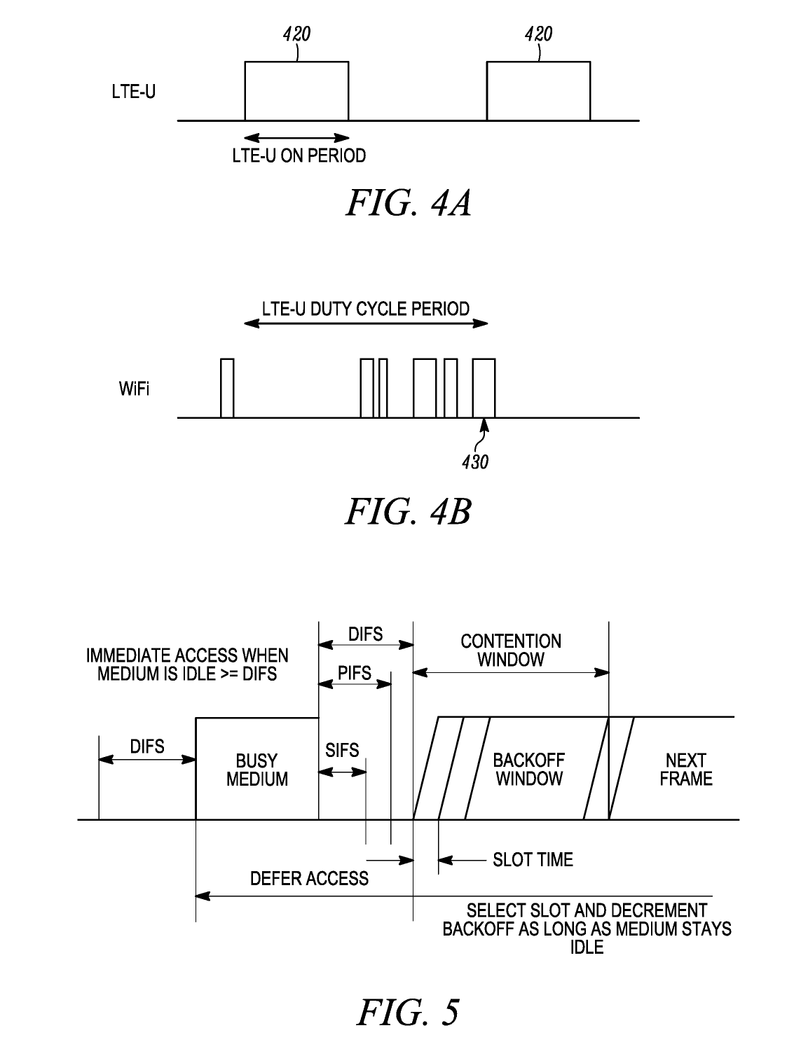

One problem that can arise when using the CSAT algorithm is that since LTE-U transmission begins irrespective of channel occupancy at pre-determined LTE-U ON start times, a Wi-Fi packet may see interference from LTE-U. This is illustrated in the timelines shown in FIGS. 4a and 4b. FIG. 4a shows two ON periods 420 of the LTE-U duty cycle and FIG. 4b show the transmission of Wi-Fi packets on the same channel. As shown, the first Wi-Fi packet 430 begins transmission during an LTE-U ON period 420. As a consequence Wi-Fi throughput is adversely impacted by edge collisions with LTE-U transmissions.

One way to address this problem is by recognizing that Wi-Fi nodes (e.g., Wi-Fi access points and/or Wi-Fi stations) use a carrier sense multiple access with collision avoidance (CSMA/CA) technique in an attempt to avoid collisions. One example of such a technique is the distributed coordination function (DCF), which is supported by the MAC layer of the IEEE 802.11 protocol. The DCE process is illustrated in the timing sequence shown in FIG. 5. In DCF, transmissions are separated by inter packet gaps known as inter frame spaces (IFS). Channel access is granted based on different priority classes. These classes are mapped on different gap durations: distributed-IFS (DIFS, also known as DCF inter-frame space), priority-IFS (PIFS, also known as PCF inter-frame spacing), and short-IFS (SIFS), with SIFS being the shortest (highest priority) and DIFS being the longest (lowest priority).

Collision detection is not used in DCF since a Wi-Fi node is unable to detect the channel and transmit data simultaneously. A node listens to the channel before transmission to determine whether someone else is transmitting. If the medium is sensed to be free for a DCF inter-frame space (DIFS) time interval the transmission will proceed. If the medium is busy the node defers its transmission until the end of the current transmission and then it will wait an additional DIFS interval and generate a random backoff delay uniformly chosen in the range [0,W-1] where W is called the backoff window or contention window (CW). The backoff timer is decreased as long as the medium is sensed to be idle for a DIFS, and frozen when a transmission is detected on the medium, and resumed when the channel is detected as idle again for a DIFS interval. When the backoff reaches 0, the station transmits its packet. For IEEE 802.11 time is slotted in a basic time unit which is the time needed to detect the transmission of a packet from any other node. The initial CW is set to W=1. If two or more Wi-Fi nodes decrease their backoff timer to 0 at the same time a collision occur, at this situation the CW is doubled for each retransmission until it reaches a maximum value.

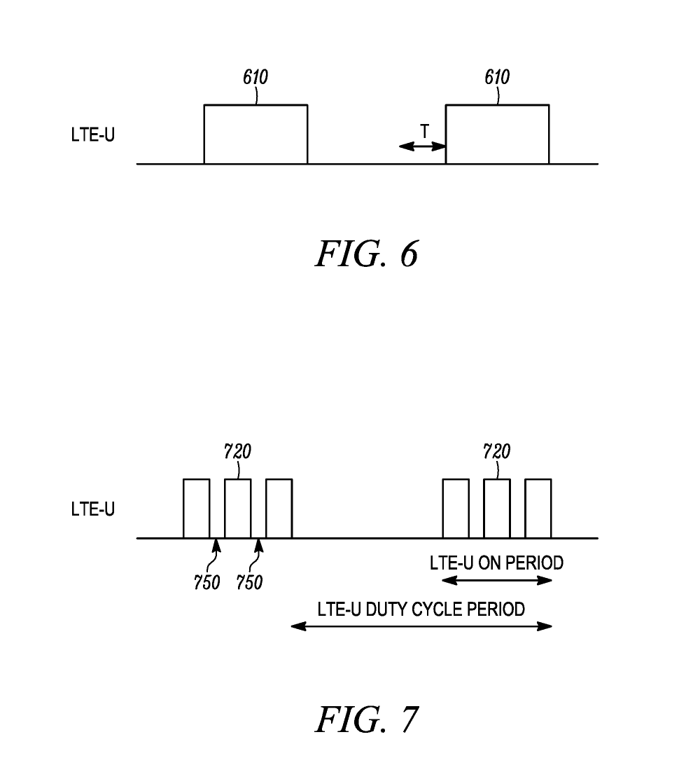

An LTE-U cell or UE can reduce the likelihood of a collision with Wi-Fi packets at the start of a pre-determined LTE-U ON period by implementing a modified listen-before-talk process in which the cell or UE listens to the channel for a period of time prior to the start of the transmission during the LTE-U ON periods of the LTE-U duty cycle. This is depicted in the timeline of the LTE-U duty cycle shown in FIG. 6, where the LTE-U or UE cell listens to the channel before transmission over a duration of time T prior to the start of transmission during an LTE-U ON period 610. If the cell senses that the channel is free for a period of time equal to a DIFS time interval or less, the cell or UE will send an IEEE 802.11 control packet such as a Clear to Send to Self (CTS2Self) packet to reserve the channel. Other Wi-Fi nodes that receive the CTS2Self packet from the LTE-U cell do not initiate Wi-Fi transmission for a period of time specified in the CTS2Self packet. Since a Wi-Fi node will defer any transmission for at least a period of time equal to the DIFS time interval, by reserving the channel before the expiration of this time interval collisions are likely to be avoided. On the other hand, if the channel is not free for more than a DIFS time interval, then LTE-U transmission may interfere with any ongoing transmission on the channel.

The interval T over which the LTE-U cell or UE listens to the channel before transmission can be increased in order to reduce the probability of collision with a Wi-Fi transmission, but at the expense of reduced overall channel usage. To balance this tradeoff, in some embodiments the value of T can be adapted based on the success rate in avoiding collisions between LTE-U transmission and Wi-Fi transmissions.

In some implementations, as shown in FIG. 7, puncturing may be used to introduce relatively frequent transmission (TX) gaps 750 during one or more of the LTE-U ON periods 720. The transmission gaps 750 may be useful for co-existence with latency-sensitive traffic of the competing Wi-Fi system, such as Voice over Internet Protocol (VoIP) traffic. For example, if the LTE-U ON period has a duration of about 100 ms, puncturing gaps 750 may be located every 20 ms therein. The gaps may have a duration, in one example, of about 1 ms. In some implementations, the listen-before-talk procedure described herein may be performed not only before the start of the LTE-U ON period, but also prior to the start of LTE-U transmission after the puncturing gap.

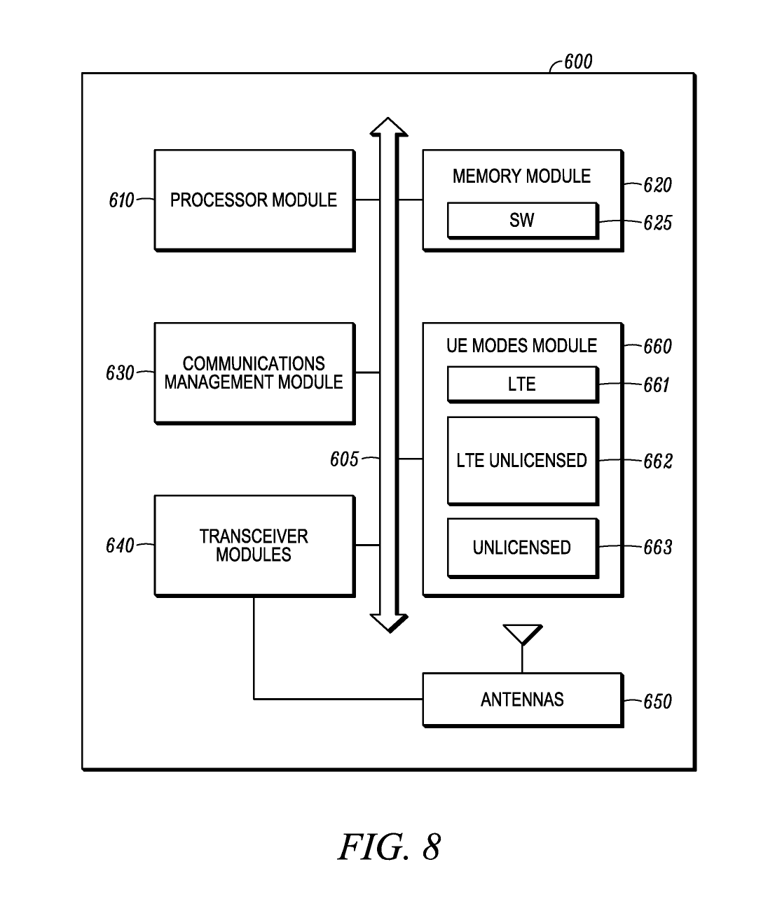

FIG. 8 is a simplified functional block diagram of one example of a UE 600 that is configured for LTE-U operation in accordance with the techniques described herein. The UE 600 may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The UE 600 may have an internal power supply (not shown), such as a small battery, to facilitate mobile operation. The UE 600 may be an example of the UEs 125 of FIG. 1.

The UE 600 may include a processor module 610, a memory module 620, a transceiver module 640, antennas 650, and an UE modes module 660. Each of these components may be in communication with each other, directly or indirectly, over one or more buses 605.

The memory module 620 may include random access memory (RAM) and read-only memory (ROM). The memory module 620 may store computer-readable, computer-executable software (SW) code 625 containing instructions that are configured to, when executed, cause the processor module 610 to perform various functions described herein for using LTE-based communications in an unlicensed spectrum. Alternatively, the software code 625 may not be directly executable by the processor module 610 but be configured to cause the computer (e.g., when compiled and executed) to perform functions described herein.

The processor module 610 may include an intelligent hardware device, e.g., a central processing unit (CPU), a microcontroller, an application-specific integrated circuit (ASIC), etc. The processor module 610 may process information received through the transceiver module 640 and/or to be sent to the transceiver module 640 for transmission through the antennas 650. The processor module 610 may handle, alone or in connection with the UE modes module 660, various aspects of using LTE-based communications in an unlicensed spectrum.

The transceiver module 640 may be configured to communicate bi-directionally with radio nodes. The transceiver module 640 may be implemented as one or more transmitter modules and one or more separate receiver modules. The transceiver module 640 may support communications in a licensed spectrum (e.g., LTE) and in an unlicensed spectrum (e.g., LTE-U). This module may also handle monitoring of activity on the unlicensed carrier and aid in determining that the carrier is unused. The transceiver module 640 may include a modem configured to modulate the packets and provide the modulated packets to the antennas 650 for transmission, and to demodulate packets received from the antennas 650. While the UE 600 may include a single antenna, there may be embodiments in which the UE 600 may include multiple antennas 650.

According to the architecture of FIG. 8, the UE 600 may further include a communications management module 630. The communications management module 630 may manage communications with various access points. The communications management module 630 may be a component of the UE 600 in communication with some or all of the other components of the UE 600 over the one or more buses 605. Alternatively, functionality of the communications management module 630 may be implemented as a component of the transceiver module 640, as a computer program product, and/or as one or more controller elements of the processor module 610.

The UE modes module 660 may be configured to perform and/or control some or all of the functions or aspects described herein related to using LTE-based communications in an unlicensed spectrum. The UE modes module 660 may include an LTE module 661 configured to handle LTE communications, an LTE unlicensed module 662 configured to handle LTE-U communications, and an unlicensed module 663 configured to handle communications other than LTE-U in an unlicensed spectrum. The UE modes module 660, or portions of it, may be a processor. Moreover, some or all of the functionality of the UE modes module 660 may be performed by the processor module 610 and/or in connection with the processor 610.

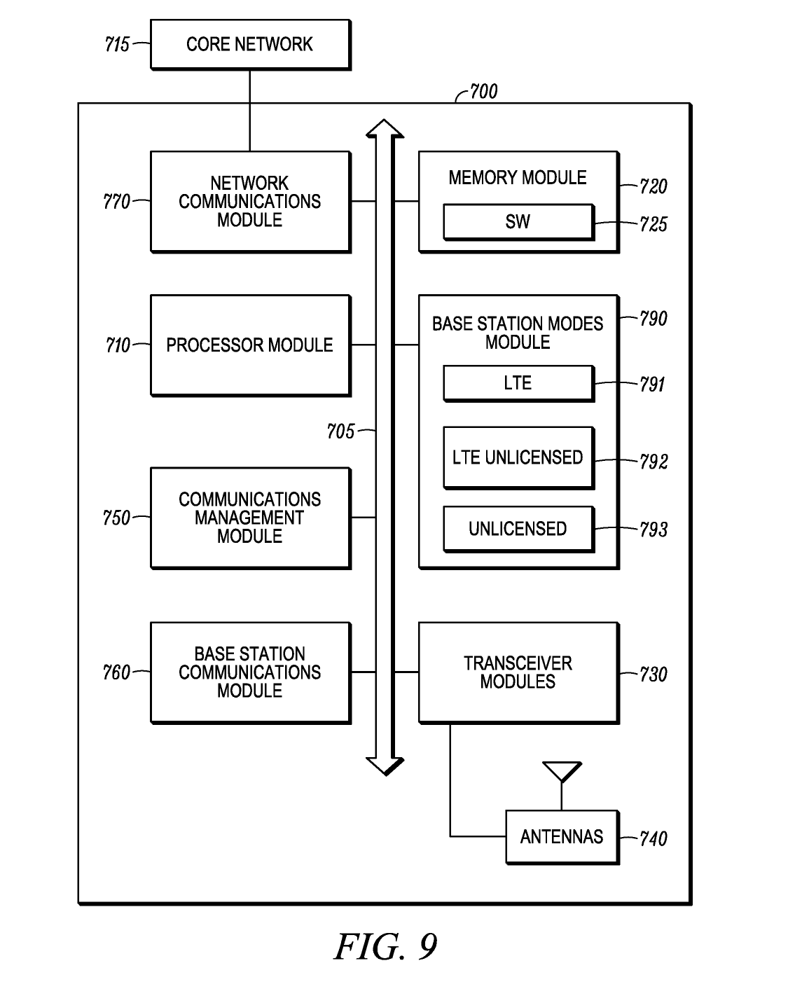

FIG. 9 is a simplified functional block diagram of one example of a radio node 700 that is configured for LTE-U operation in accordance with the techniques described herein. In some embodiments, the radio node 700 may be an example of the radio nodes 115 of FIG. 1. The radio node 700 may include a processor module 710, a memory module 720, a transceiver module 730, antennas 740, and a radio node modes module 790. The radio node 700 may also include one or both of a radio node communications module 760 and a network communications module 770. Each of these components may be in communication with each other, directly or indirectly, over one or more buses 705.

The memory module 720 may include RAM and ROM. The memory module 720 may also store computer-readable, computer-executable software (SW) code 725 containing instructions that are configured to, when executed, cause the processor module 710 to perform various functions described herein for using LTE-based communications in an unlicensed spectrum. Alternatively, the software code 725 may not be directly executable by the processor module 710 but be configured to cause the computer, e.g., when compiled and executed, to perform functions described herein.

The processor module 710 may include an intelligent hardware device, e.g., a CPU, a microcontroller, an ASIC, etc. The processor module 710 may process information received through the transceiver module 730, the radio node communications module 760, and/or the network communications module 770. The processor module 710 may also process information to be sent to the transceiver module 730 for transmission through the antennas 740, to the radio node communications module 760, and/or to the network communications module 770. The processor module 710 may handle, alone or in connection with the radio node modes module 790, various aspects of using LTE-based communications in an unlicensed spectrum.

The transceiver module 730 may include a modem configured to modulate the packets and provide the modulated packets to the antennas 740 for transmission, and to demodulate packets received from the antennas 740. The transceiver module 730 may be implemented as one or more transmitter modules and one or more separate receiver modules. The transceiver module 730 may support communications in a licensed spectrum (e.g., LTE) and in an unlicensed spectrum (e.g., LTE-U). The transceiver module 730 may be configured to communicate bi-directionally, via the antennas 740, with one or more UEs 115 as illustrated in FIG. 1, for example. The transceiver module could also handle monitoring of activity on the unlicensed carrier and to aid in determining that the carrier is unused. The radio node 700 may typically include multiple antennas 740 (e.g., an antenna array). The radio node 700 may communicate with a core network 715 directly or indirectly (e.g., though an access controller) through the network communications module 770. The core network 715 may be an example of the core network 140 of FIG. 1. The radio node 700 may communicate with other radio nodes using the radio node communications module 760.

According to the architecture of FIG. 9, the radio node 700 may further include a communications management module 750. The communications management module 750 may manage communications with stations and/or other devices. The communications management module 750 may be in communication with some or all of the other components of the radio node 700 via the bus or buses 705. Alternatively, functionality of the communications management module 750 may be implemented as a component of the transceiver module 730, as a computer program product, and/or as one or more controller elements of the processor module 710.

The radio node modes module 790 may be configured to perform and/or control some or all of the functions or aspects described herein related to using LTE-based communications in an unlicensed spectrum. For example, the radio node modes module 790 may be configured to support communications in the unlicensed spectral band used by IEEE 802.11 systems. The radio node modes module 790 may include an LTE module 791 configured to handle LTE communications, an LTE unlicensed module 792 configured to handle LTE-U communications, and an unlicensed module 793 configured to handle communications other than LTE-U in an unlicensed spectrum. The radio node modes module 790, or portions of it, may be a processor. Moreover, some or all of the functionality of the radio node modes module 790 may be performed by the processor module 710 and/or in connection with the processor 710.

Several aspects of telecommunication systems will now be presented with reference to the UEs and radio nodes described in the foregoing detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionalities described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable media. Non-transitory computer-readable media may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable media for storing software. The non-transitory computer-readable media may be resident in the processing system, external to the processing system, or distributed across multiple entities including the processing system. Non-transitory computer-readable media may be embodied in a computer-program product. By way of example, a computer-program product may include one or more computer-readable media in packaging materials. Those skilled in the art will recognize how best to implement the described functionality presented throughout this disclosure depending on the particular application and the overall design constraints imposed on the overall system.

1. A method of communicating over a channel in a frequency band shared by different radio access technologies, comprising:
prior to transmitting a signal beginning at a predetermined time on a first channel in a frequency band in accordance with a first radio access technology (RAT), sensing if the first channel is unoccupied during a specified first duration of time for a specified second duration of time; and
if the first channel is unoccupied for the specified second duration of time, immediately transmitting a channel reservation signal on the first channel, the channel reservation signal being decodable by a node operating in accordance with a second RAT different from the first RAT.

2. The method of claim 1, wherein the second duration of time is adaptively adjustable based at least in part on a rate of success in avoiding collisions between transmission on the first channel by the first and second RATs.

3. The method of claim 1, wherein the second RAT is Wi-Fi

4. The method of claim 1, wherein the first RAT is based on LTE.

5. The method of claim 4, wherein the first RAT is LTE-U.

6. The method of claim 5, wherein the sensing is performed prior to the start of an LTE-U transmission ON period of a second node employing the first RAT.

7. The method of claim 3, wherein the specified second duration of time is a distributed inter-frame coordination function (DIFS) space interval specified by a distributed coordination function (DCF).

8. The method of claim 3, wherein the channel reservation signal is a CTS2Self packet.

9. The method of claim 1, wherein the sensing is performed prior to transmission by a second node employing the first RAT.

10. The method of claim 9, wherein the second node is a radio node operating in a small cell RAN.

11. The method of claim 9, wherein the second node is a UE.

12. The method of claim 6, wherein the transmission ON period includes at least one puncturing gap during which time the first channel is unoccupied by the second node so that the node may transmit in accordance with the second RAT.

13. The method of claim 12, further comprising sensing if the first channel is unoccupied before the second node resumes transmission.

14. The method of claim 1, wherein the frequency band is an unlicensed frequency band.
